(19) United States
(12) Patent Application Publication
(10) Pub. No.: US 2023/0198906 A1
(43) Pub. Date: Jun. 22, 2023

(54) ISOLATING VIRTUAL DESKTOP APPLICATIONS FOR POLICY ENFORCEMENT

(71) Applicant: VMware, Inc., Palo Alto, CA (US)

(72) Inventors: Dinesh Kumar Kamalakannan, Bengaluru (IN); Sudarshana Kandachar Sridhara Rao, Bangalore (IN); Syed Tayassar Shah, Mysuru (IN); Mittali Chawla, Bengaluru (IN); Abhinav Modi, Bengaluru (IN)

(21) Appl. No.: 17/966,799

(22) Filed: Oct. 15, 2022

(30) Foreign Application Priority Data
Dec. 16, 2021 (IN) 202141058703
Dec. 16, 2021 (IN) 202141058750

(51) Int. Cl. H04L 47/125; H04L 47/2475; H04L 47/20

(52) U.S. Cl. CPC H04L 47/125; H04L 47/2475; H04L 47/20

(57) ABSTRACT

Some embodiments provide a method of enforcing a set of access policies on traffic exchanged between remote clients and virtual desktop applications. This method receives and stores access policies that define access to different virtual desktop applications by remote clients. To a set of one or more access gateways remote, the method forwards client requests to launch virtual desktop applications. The method analyzes responses provided by the gateway set to virtual desktop requests, and based on this analysis, creates records that identify the virtual applications that will be launched. The method passes the gateway responses back to the remote clients, and upon receiving traffic to the identified virtual applications from the remote clients, (1) uses the created records to identify the virtual applications associated with the received traffic and (2) applies the access policies associated with the identified virtual applications to the received traffic.

### BACKGROUND

Virtual Desktop Infrastructure (VDI) enables delivering virtual applications and virtual desktops securely to remote clients, typically via an encrypted tunnel such as PCoIP, VMware Blast, or RDP. With working from home being the new normal, the VDI bandwidth utilization in datacenters is increasing tremendously as many applications are being utilized on VDI platforms. Also, VDI applications are hosted in multiple datacenters across regions, at times managed by a single federation manager. In some existing systems, VDI user traffic is directed to designated application pool servers using native administrative policies or via external network load balancers. Load balancers are positioned in front of VDI gateways to scale the application server load received across locations. The virtualized applications/desktops are delivered to remote clients over an encrypted tunnel.

The load balancers in some systems reside in a Demilitarized Zone (DMZ), and are not aware of the VDI tunneling protocol. In addition, integrating VDI tunneling protocol to any native load balancer product is not a viable option due to product complexities, inter-operability issues, and additional compute resources needed for analyzing traffic. This poses a problem for IT teams looking to manage/classify applications on-demand to apply differential policies at the load balancer. Moreover, in the case of large-scale environments including multiple data centers (GSLB sites) and many VDI gateways, it becomes tedious to apply policies on each server/pod across multiple locations. This could increase operational complexity for admins resulting in errors and inconsistencies in configuration.

### BRIEF SUMMARY

Some embodiments provide a method of enforcing a set of access policies on traffic exchanged between remote clients and virtual desktop applications. In some embodiments, this method is performed by a forwarding element that facilitates the exchange of traffic between remote clients and resources that provide the virtual desktop applications. The forwarding element in some embodiments is a load balancer, while in other embodiments it is another type of forwarding element. According to some embodiments of this method, the forwarding element initially receives and stores access policies that define access to different virtual desktop applications by remote clients.

To a set of one or more remote access gateways, the forwarding element subsequently forwards client requests to launch virtual desktop applications. The forwarding element analyzes responses provided by the gateway set to virtual desktop requests, and based on this analysis, creates records that identify the virtual applications that will be launched. The forwarding element passes the gateway responses back to the remote clients, and upon receiving traffic to the identified virtual applications from the remote clients, (1) uses the created records to identify the virtual applications associated with the received traffic and (2) applies the access policies associated with the identified virtual applications to the received traffic.

In some embodiments, the gateway-provided responses allow the remote clients to establish secure encrypted communication with resources that provide the requested virtual applications. The forwarding element that applies the access policies does not decrypt this communication in order to identify the virtual applications associated with the communications, but rather uses the records that it created while it was facilitating the establishment of secure connections between remote clients and the resources that were identified by the access gateway set as resources that would provide the virtual applications to the remote clients.

In response to a request to launch a virtual application from a remote client, an access gateway in some embodiments provides a response (e.g., an XML, response file) that includes data specifying (1) a resource that will provide the virtual desktop application and (2) a first port for the remote client to use to establish a connection with the resource to receive the virtual desktop application. When the forwarding element receives such a response, the forwarding element replaces in the gateway response the first port with a second port, before forwarding to the remote client the gateway's response.

The forwarding element also creates a set of one or more connection tracking records that associates the first and second ports and an identifier associated with the requested virtual desktop application. Upon receiving traffic from the remote client to the resource identified by the access gateway, the forwarding element uses the connection tracking record set to identify traffic between the remote client and the resource, and to perform access policy enforcement on the traffic that is associated with the virtual application identified in the connection tracking record set.

Assuming that the application of the access policy enforcement does not result in the dropping of the traffic, the forwarding element replaces, in the communication from the remote client to the resource providing the virtual desktop application, the second port with the first port before forwarding the communication to the resource. During the connection session associated with the requested virtual desktop application, the forwarding element also replaces the first port with the second port when forwarding communication from the resource to the remote client.

In some embodiments, examples of access policies include rate limiting policies, security policies and web access firewall (WAF) policies. A rate limiting policy in some embodiment specifies a rate (e.g., a maximum rate) associated with traffic exchanged between a remote client and a virtual desktop application associated with the rate limiting policy. A security policy in some embodiments can allow or block remote access request from a set of network addresses to a virtual desktop application associated with the security policy. Similarly, a WAF policy is a firewall policy that in some embodiments is applied to a set of network addresses that try to access a virtual desktop application associated with the WAF policy in order to allow or reject access by address set to the virtual desktop application. Also, in some embodiments, the access policies can be defined for one particular virtual desktop application, a particular group of two or more virtual desktop applications, and/or a particular virtual desktop that comprises a set of one or more applications.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates a VDI architecture 100 that uses the method of some embodiments of the invention.

FIG. 2 illustrates a process performed by a frontend load balancer to parse and process the XML response provided by the UAG server to a remote client's VDI request, and to create and subsequently use connection tracking record(s) that allow it to perform policy enforcement for accessing VDI applications and/or desktops.

FIG. 3 illustrates an example of the controller cluster providing to the frontend load balancer cluster policy configuration data 305 for VDI applications and desktops.

FIG. 4 illustrates examples of access policies.

FIG. 5 illustrates an example of the frontend load balancer receiving a request for a VDI application/desktop from a remote client.

FIG. 6 illustrates the frontend load balancer processing the XML data from the UAG server and creating its connection tracking record(s).

FIG. 7 illustrates examples of a connection tracking storage of the frontend load balancer.

FIG. 8 illustrates an example of the remote client providing the launch request.

FIG. 9 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method of enforcing a set of access policies on traffic exchanged between remote clients and virtual desktop applications. In some embodiments, this method is performed by a forwarding element that facilitates the exchange of traffic between remote clients and resources that provide the virtual desktop applications. The forwarding element in some embodiments is a load balancer, while in other embodiments it is another type of forwarding element.

In some embodiments, the forwarding element initially receives and stores access policies that define access to different virtual desktop applications by remote clients. To a set of one or more access gateways remote, the forwarding element subsequently forwards client requests to launch virtual desktop applications. The forwarding element analyzes responses provided by the gateway set to virtual desktop requests, and based on this analysis, creates records that identify the virtual applications that will be launched. The forwarding element passes the gateway responses back to the remote clients, and upon receiving traffic to the identified virtual applications from the remote clients, (1) uses the created records to identify the virtual applications associated with the received traffic and (2) applies the access policies associated with the identified virtual applications to the received traffic.

In some embodiments, the gateway-provided responses allow the remote clients to establish secure encrypted communication with resources that provide the requested virtual applications. The forwarding element that applies the access policies does not decrypt this communication in order to identify the virtual applications associated with the communications, but rather uses the records that it created while it was facilitating the establishment of secure connections between remote clients and the resources that were identified by the access gateway set as resources that would provide the virtual applications to the remote clients.

In response to a request to launch a virtual application from a remote client, an access gateway in some embodiments provides a response (e.g., an XML, response file) that includes data specifying (1) a resource that will provide the virtual desktop application and (2) a first port for the remote client to use to establish a connection with the resource to receive the virtual desktop application. When the forwarding element receives such a response, the forwarding element replaces in the gateway response the first port with a second port, before forwarding to the remote client the gateway's response.

The forwarding element also creates a set of one or more connection tracking records that associates the first and second ports and an identifier associated with the requested virtual desktop application. Upon receiving traffic from the remote client to the resource identified by the access gateway, the forwarding element uses the connection tracking record set to identify traffic between the remote client and the resource, and to perform access policy enforcement on the traffic that is associated with the virtual application identified in the connection tracking record set.

Assuming that the application of the access policy enforcement does not result in the dropping of the traffic, the forwarding element replaces, in the communication from the remote client to the resource providing the virtual desktop application, the second port with the first port before forwarding the communication to the resource. During the connection session associated with the requested virtual desktop application, the forwarding element also replaces the first port with the second port when forwarding communication from the resource to the remote client.

In some embodiments, examples of access policies include rate limiting policies, security policies and web access firewall (WAF) policies. A rate limiting policy in some embodiment specifies a rate (e.g., a maximum rate) associated with traffic exchanged between a remote client and a virtual desktop application associated with the rate limiting policy. A security policy in some embodiments can allow or block remote access request from a set of network addresses to a virtual desktop application associated with the security policy. Similarly, a WAF policy is a firewall policy that in some embodiments is applied to a set of network addresses that try to access a virtual desktop application associated with the WAF policy in order to allow or reject access by address set to the virtual desktop application. Also, in some embodiments, the access policies can be defined for one particular virtual desktop application, a particular group of two or more virtual desktop applications, and/or a particular virtual desktop that comprises a set of one or more applications.

As used in this document, data messages refer to a collection of bits in a particular format sent across a network. One of ordinary skill in the art will recognize that the term data message is used in this document to refer to various formatted collections of bits that are sent across a network. The formatting of these bits can be specified by standardized protocols or non-standardized protocols. Examples of data messages following standardized protocols include Ethernet frames, IP packets, TCP segments, UDP datagrams, etc. Also, as used in this document, references to L2, L3, L4, and L7 layers (or layer 2, layer 3, layer 4, and layer 7) are references respectively to the second data link layer, the third network layer, the fourth transport layer, and the seventh application layer of the OSI (Open System Interconnection) layer model.

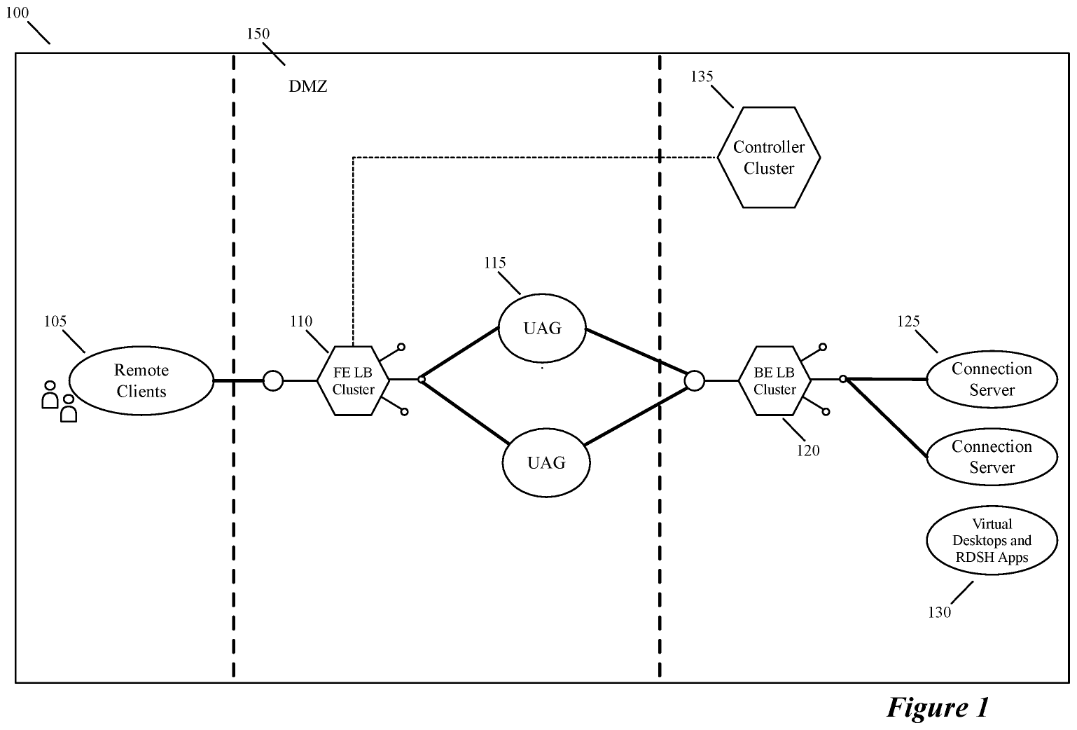

FIG. 1 illustrates a VDI architecture 100 that uses the method of some embodiments of the invention. The VDI architecture delivers virtual application and virtual desktops securely to remote clients through encrypted tunnel (such as PCoIP, VMware Blast, or RDP). Also, in this architecture, the VDI applications are hosted in multiple datacenters across multiple regions. As shown, the VDI architecture 100 includes one or more remote clients 105, frontend load balancer cluster 110, a set of one or more unified access gateway (UAG) servers 115, backend load balancer cluster 120, a set of one or more connection servers 125, several virtual desktop and applications 130 and a controller cluster 135.

The frontend load balancer cluster 110 directs VDI user traffic to designated application pool servers 130 through the UAG servers 115 in order to scale the application server load received across locations. In some embodiments, the frontend load balancer cluster resides in a Demilitarized Zone (DMZ) 150, and is not aware of the VDI tunneling protocols that are used to deliver virtualized applications/desktops to remote clients. As further described below, the load balancer cluster in some embodiments is configured by the controller cluster 135 with policies that enable this cluster to perform policy enforcement on data traffic exchanged between VDI remote clients and the VDI desktops/applications.

Using the methodology of some embodiments, the frontend load balancer cluster performs its policy enforcement at granular level of VDI application and application groups. This enforcement capability allows IT teams to manage/classify applications on-demand to apply differential policy at the load balancer. Also, in case of large-scale environments with multiple datacenters (e.g., multiple GSLB sites) and many VDI gateways, this enforcement approach simplifies consistent definition and enforcement of policies for each application server/pod across multiple locations.

When a remote client 105 tries to access a VDI application/desktop, the load balancer 110 receives the request. This request in some embodiments is an XML-API request. The load balancer parses this request and performs a load balancing service based on the data parsed from this request. In some embodiments, the load balancing service is a L7 Service. Based on this load balancing, the load balancer selects a UAG server 115 that acts as a VDI gateway.

The UAG server then authenticates the user (e.g., based on data contained in the XML-API). After the authentication of the client, the UAG server forwards the request to a connection server 125 that is selected by the backend load balancing cluster 120. From the connection server 125 selected by the backend load balancing cluster 120, the UAG server receives data relating to the application and/or desktop that the remote client can access. The UAG server then sends to the client, through the frontend load balancer cluster 110, an XML file containing the information relating to the application and/or desktop that the remote client can access. The load balancer 110 parses this XML data, and processes this data to create one or more records that allow the frontend load balancer 110 to subsequently perform its granular policy enforcement on VDI traffic exchanged between the remote client 105 and the designated server (i.e., the server 130 designated by the connection server 125) for providing the requested VDI application/desktop 130.

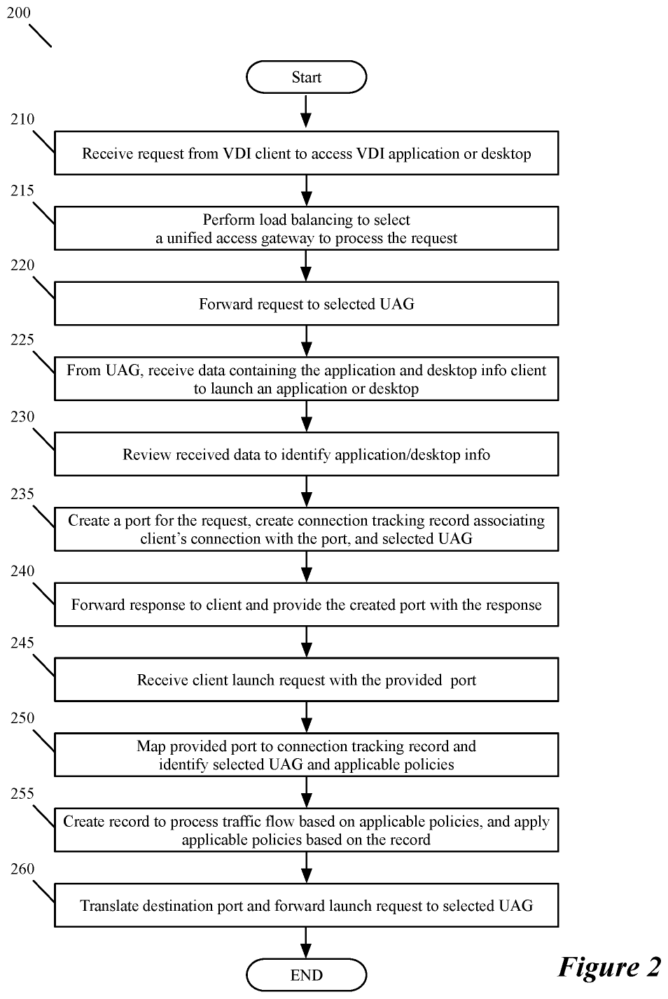

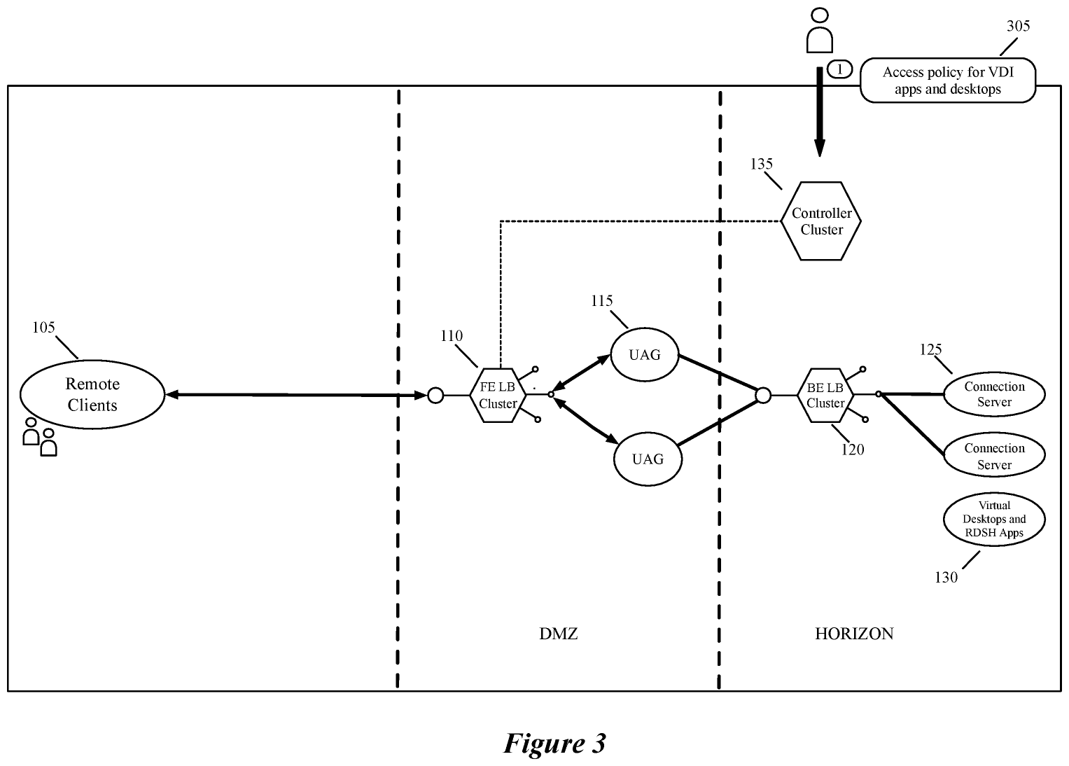

FIG. 2 illustrates a process 200 performed by a frontend load balancer 110 to parse and process the XML response provided by the UAG server to a remote client's VDI request, and to create and subsequently use connection tracking record(s) that allow it to perform policy enforcement for accessing VDI applications and/or desktops. The process 200 will be described below by reference a data flow example illustrated in FIGS. 3-6.

Before the process 200 starts, the frontend load balancer 110 receives access policies from the controller cluster 135. The frontend load balancer 110 stores these policies in its policy storage (not shown). These policies allow the frontend load balancer to perform policy enforcement on data traffic exchanged between VDI remote clients and the VDI desktops/applications. FIG. 3 illustrates an example of the controller cluster 135 providing to the frontend load balancer cluster 110 policy configuration data 305 for VDI applications and desktops.

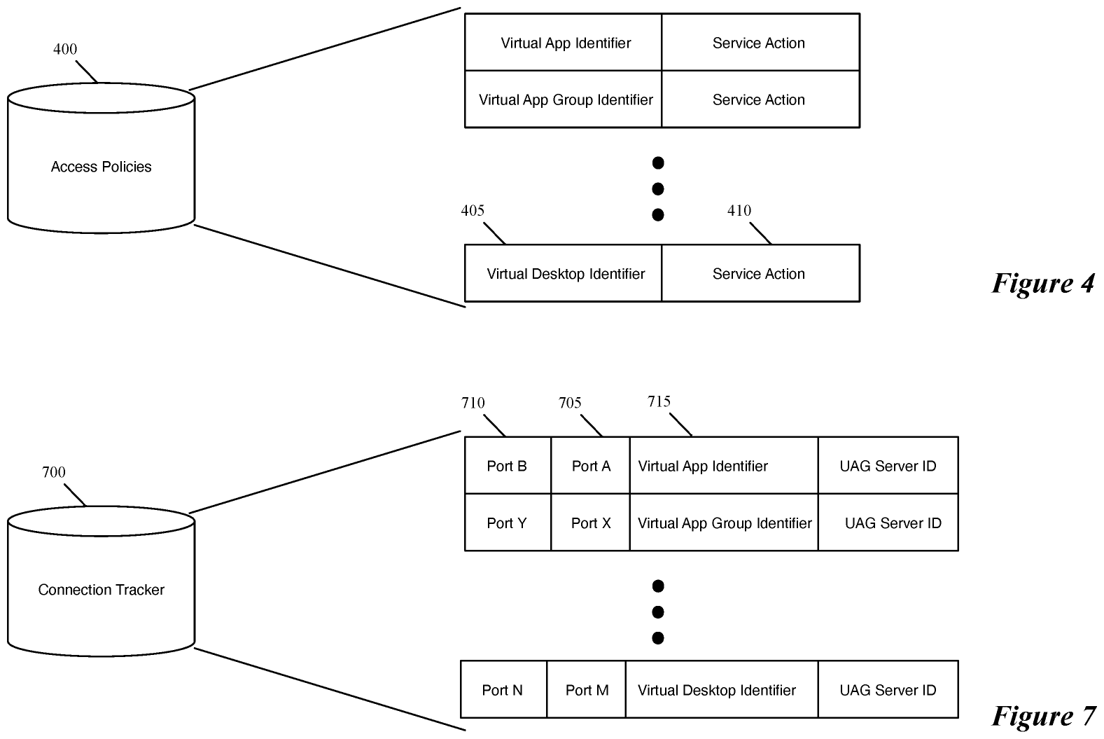

In some embodiments, the access policies can include rate limiting policies, security policies and web access firewall (WAF) policies, as described above. As shown in FIG. 4, each policy in some embodiments (1) has an identifier 405 that identifies an virtual application, a virtual application group, and/or a virtual desktop, and (2) specifies a service action 410 for the associated application, application group or virtual desktop. When the load balancer associates the remote client's traffic with a virtual application, a group of virtual applications or virtual desktop, the load balancer identifies the access policy that matches the virtual application, application group, or virtual desktop, and then performs a service operation specified by the matching access policy.

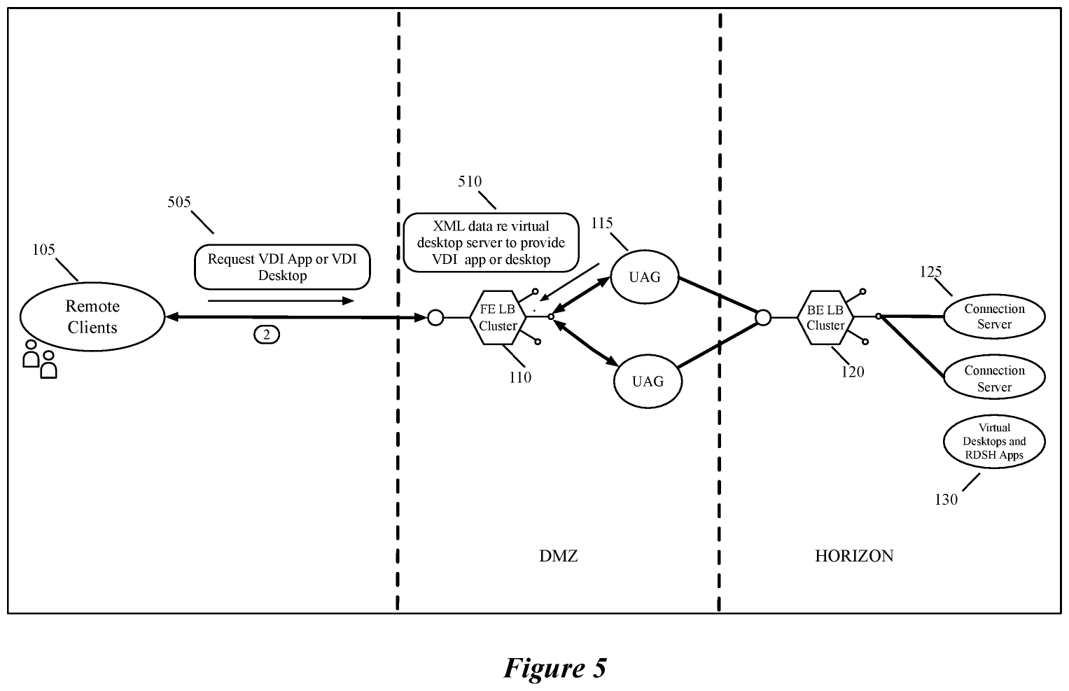

The process 200 starts when the frontend load balancer receives (at 210) a remote client 105 request to launch a VDI application/desktop. FIG. 5 illustrates an example of the frontend load balancer 110 receiving a request 505 for a VDI application/desktop from a remote client 105. This request is an XML-API request in some embodiments. The load balancer (at 215) parses this request and performs a load balancing service based on the data parsed from this request. In some embodiments, the load balancing service is a L7 Service. Based on this load balancing, the load balancer selects a UAG server 115 that acts as a VDI gateway and forwards (at 220) the remote client's request to the selected UAG server 115.

The UAG server then authenticates the user (e.g., based on data contained in the XML-API). After the authentication of the client, the UAG server forwards the request to a connection server 125 that is selected by the backend load balancing cluster 120. From the connection server 125 selected by the backend load balancing cluster 120, the UAG server receives data relating to the application and/or desktop that the remote client can access, and then forwards this data as XML data to the frontend load balancer that sent it the remote client request. FIG. 5 illustrates an example of the UAG server providing XML data 510 to the frontend load balancer.

An example of such XML data is as follows:

```
-<application-connection>
  <result>ok</result>
  <id>cn=app1,ou=applications,dc=vdi,dc=vmware,dc=int</id>
  <session-
id>DOMAIN1\user1(cn=...,dc=vdi,dc=vmware,dc=int)/0@cn=...:APPLICATION
</session-id>
  <new-connection-needed>true</new-connection-needed>
  <address>11.11.11.11</address>
  <port>A</port>
```

As shown, the XML, data includes a virtual IP address (11.11.11.11) and a destination port address (port A). The virtual IP address is configured on the load balancer 110 to which the remote client 105 will connect using the destination port address (port A) to get the requested VDI application rendered. Examples of such port addresses for VDI applications include ports 8443 or 4172. In some embodiments, the XML data can provide the address of the virtual application(s) in terms of an IP address or a fully qualified domain name (FQDN). In case of FQDN, the FQDN needs to be DNS resolved by the remote client 105 to an IP address configured on the load balancer 110.

At 225, the load balancer process 200 receives from the UAG server the XML data containing the information relating to the server that the remote client should access to receive the virtual application and/or desktop that the remote client has requested. The load balancer 110 parses (at 230) this XML data to identify the virtual application, application group or desktop associated with the request, and processes (at 235) this data to create one or more connection tracking records that allow the load balancer 110 to subsequently perform its granular policy enforcement on VDI traffic exchanged between the remote client 105 and the designated server (i.e., the server 130 designated by the connection server 125) for providing the requested VDI application/desktop 130.

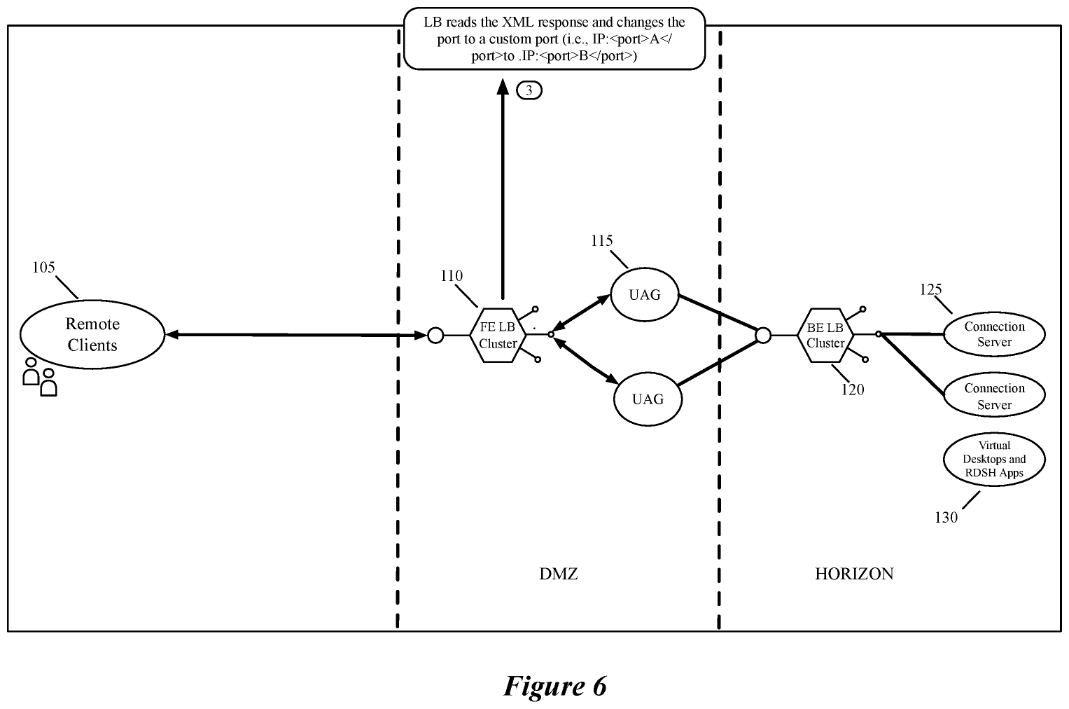

FIG. 6 illustrates the frontend load balancer 110 processing the XML data from the UAG server and creating its connection tracking record(s). In this example, the load balancer reads the XML data, and modifies the “port” XML tag value from port A to a custom port B (i.e., <port>A</port> gets modified to <port>B</port>) before forwarding the response to the remote client. In this example, the load balancer also creates a connection-tracking record that associates port B to port A and the virtual application (app1) identified in the XML data provided above.

FIG. 7 illustrates examples of a connection tracking storage 700 of the frontend load balancer 110. As shown, this connection tracking storage includes several records for severs remote virtual desktop connections. Each record associates two ports, a first port 705 supplied by the connection and UAG servers, and a second port 710 that the load balancer uses to replace the first port in the XML data supplied to the remote client. In this example, each record also specifies an identifier 715 that specifies the requested virtual application, virtual application group or virtual desktop that is associated with the remote virtual application/desktop connection associated with the record. Each record in some embodiments also includes an identifier that identifies the UAG server to use for the record's associated connection. This is the UAG server that the load balancer selected at 215 and that provided the XML data that the load balancer processed at 230.

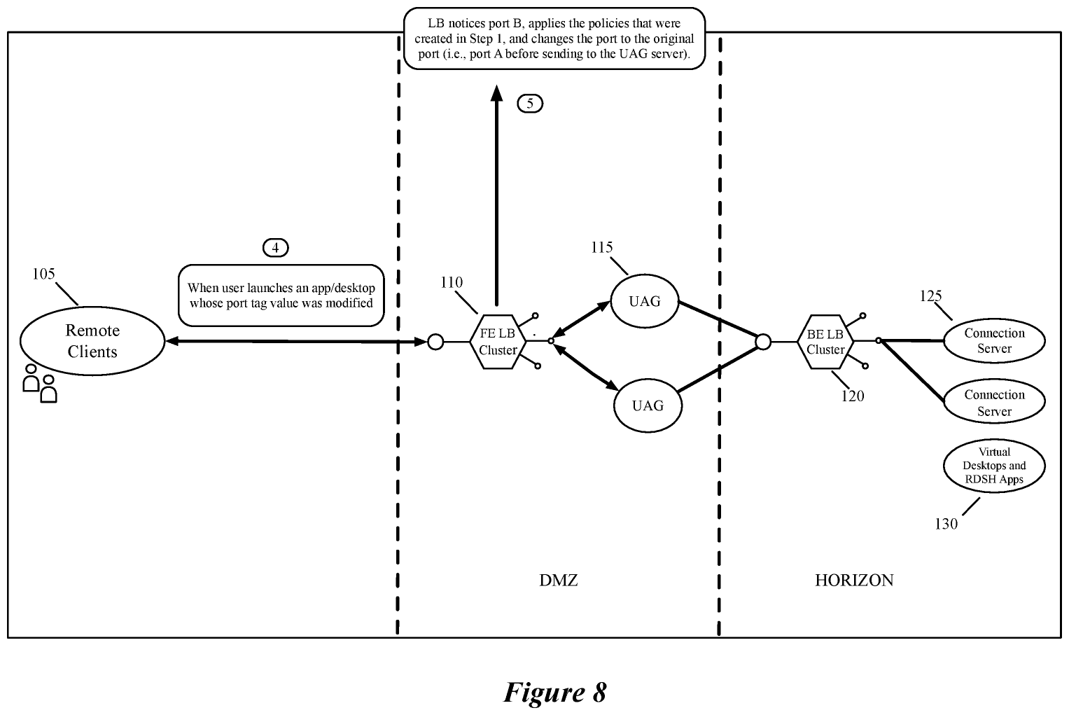

At 240, the load balancer forwards the XML, data to the remote client that sent the VDI request at 210. The forwarded XML data includes the replaced destination port (e.g., port B in the above-described example). At 245, the load balancer then receives from the client a launch request for the requested virtual application, virtual application group or virtual desktop requested by the remote client. This request includes the replaced destination port (e.g., port B in the above-described example). FIG. 8 illustrates an example of the remote client providing the launch request.

Next, at 250, the load balancer uses its connection tracking records to map the provided destination port address to the destination port address to use in forwarding the client's request to the UAG server. As mentioned above, the UAG server is also identified by the connection tracking record that matches the destination address provided in the client's launch request. FIG. 8 illustrates an example of the remote client mapping the destination port provided in the launch request to the destination port for establishing a connection with the server that will provide the requested virtual application, virtual application group or virtual desktop requested by the remote client.

The connection tracking record identified at 250 also provides the identifier of the virtual application, virtual application group or virtual desktop requested by the remote client. At 250, the load balancer uses this app, group or desktop identifier to identify an access policy to apply to the data message flows exchanged between the remote client and the server that will provide the virtual application, virtual application group or virtual desktop requested by the remote client. In some embodiments, the identified access policy is the highest priority access policy that as a policy identifier that matches the app, group or desktop identifier retrieved from the connection tracking record identified at 250.

At 255, the load balancer then creates another connection tracking record or augments the existing record to include the access policy applicable to the data message flow exchanged between the remote client and the server that will provide the virtual application, virtual application group or virtual desktop requested by the remote client. In some embodiment, the load balancer identified this access policy at 235 and included an identifier identified this policy in the connection tracking record created at 235.

At 255, the load balancer begins to apply the identified access policy to the data message flow exchanged between the remote client and the server that will provide the virtual application, virtual application group or virtual desktop requested by the remote client. Each time that the load balancer receives a data message exchanged between the remote client and the server as part of a connection established by the process 200, the load balancer retrieves from its connection tracking storage the identifier specifying the access policy to enforce and then enforces this policy based on the policy's action parameter on the data message. As mentioned above, examples of such access policy include a rate limiting policy, a security policy or a WAF policy in some embodiments.

Lastly, at 260, the load balancer replaces the destination port in the launch request with the destination port specified in the connection tracking record identified at 250 (e.g., changes destination port B to destination port A in the above-described example), and then forwards the remote client's launch request to the UAG server that should process this request. After 260, the process continues applying the access policy applicable to the VDI connection until the connection ends or the access policy is no longer needed to be applied (e.g., the access policy was a WAF policy that specified that the connection should be allowed).

The above-described architecture of FIGS. 1-8 has several advantages. It provides policy management for the load balancer at a granularity of VDI applications and desktops. This management scheme can define and enforce different levels of policy for business critical and non-critical applications. It minimizes the load balancers overhead for deciphering Blast/PCoIP to perform the policy enforcement. This architecture optimizes the performance of the load balancer as it allows the load balancer to manage VDI application traffic at the level of application groups.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

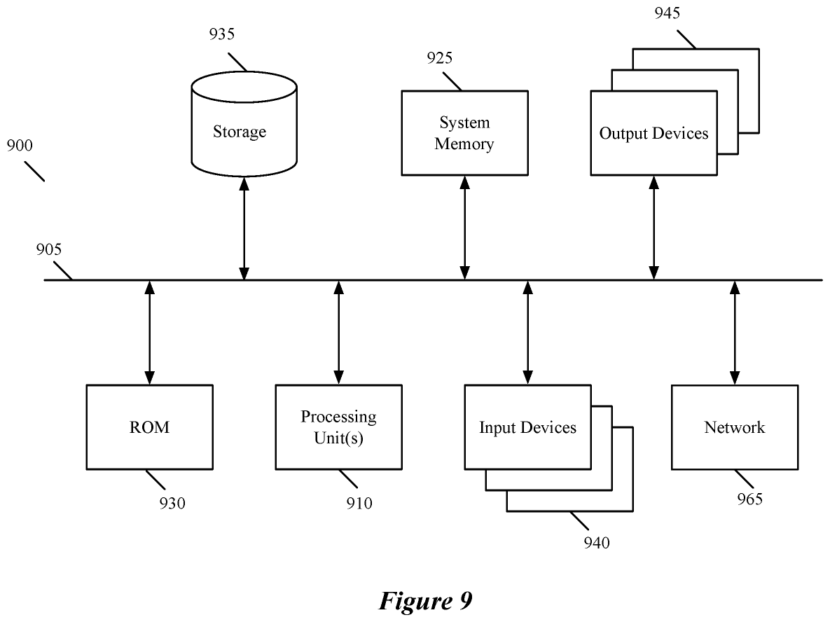

FIG. 9 conceptually illustrates a computer system 900 with which some embodiments of the invention are implemented. The computer system 900 can be used to implement any of the above-described computers and servers. As such, it can be used to execute any of the above described processes. This computer system includes various types of non-transitory machine readable media and interfaces for various other types of machine readable media. Computer system 900 includes a bus 905, processing unit(s) 910, a system memory 925, a read-only memory 930, a permanent storage device 935, input devices 940, and output devices 945.

The bus 905 collectively represents all system, peripheral, and chipset buses that communicatively connect the numerous internal devices of the computer system 900. For instance, the bus 905 communicatively connects the processing unit(s) 910 with the read-only memory 930, the system memory 925, and the permanent storage device 935.

From these various memory units, the processing unit(s) 910 retrieve instructions to execute and data to process in order to execute the processes of the invention. The processing unit(s) may be a single processor or a multi-core processor in different embodiments. The read-only-memory (ROM) 930 stores static data and instructions that are needed by the processing unit(s) 910 and other modules of the computer system. The permanent storage device 935, on the other hand, is a read-and-write memory device. This device is a non-volatile memory unit that stores instructions and data even when the computer system 900 is off. Some embodiments of the invention use a mass-storage device (such as a magnetic or optical disk and its corresponding disk drive) as the permanent storage device 935.

Other embodiments use a removable storage device (such as a flash drive, etc.) as the permanent storage device. Like the permanent storage device 935, the system memory 925 is a read-and-write memory device. However, unlike storage device 935, the system memory is a volatile read-and-write memory, such a random access memory. The system memory stores some of the instructions and data that the processor needs at runtime. In some embodiments, the invention's processes are stored in the system memory 925, the permanent storage device 935, and/or the read-only memory 930. From these various memory units, the processing unit(s) 910 retrieve instructions to execute and data to process in order to execute the processes of some embodiments.

The bus 905 also connects to the input and output devices 940 and 945. The input devices enable the user to communicate information and select commands to the computer system. The input devices 940 include alphanumeric keyboards and pointing devices (also called “cursor control devices”). The output devices 945 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 9, bus 905 also couples computer system 900 to a network 965 through a network adapter (not shown). In this manner, the computer can be a part of a network of computers (such as a local area network (“LAN”), a wide area network (“WAN”), or an Intranet, or a network of networks, such as the Internet. Any or all components of computer system 900 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method of performing load balancing for traffic exchanged between a remote client and a virtual desktop application, the method comprising:
at a load balancer:
performing a load balancing operation to select a gateway to receive a request, from a remote client, to access the virtual desktop application;
receiving from a gateway data specifying (i) a resource that will provide the virtual desktop application and (ii) a first port to use to establish a connection with the resource to receive the virtual desktop application;
forwarding to the remote client the received data after replacing in the received data the first port with a second port;
creating a set of one or more connection tracking records that associates the first and second ports;
using the connection tracking record set subsequently to forward to the gateway data messages received from the remote client that have header that specify the second port as destination ports of the data messages.

2. The method of claim 1 further comprising replacing the second port with the first port in the data messages forwarded to the gateway from the remote client.

3. The method of claim 1 further comprising:
storing in the connection tracking record set identity of the virtual desktop application;
applying access policies on traffic exchanged between the remote client and the gateway based on the identity of the virtual desktop application that is retrieved from the connection tracking record set.

4. The method of claim 3, wherein the access policies comprise at least one rate limiting policy that specifies a rate associated with traffic exchanged between a remote client and a virtual desktop application associated with the rate limiting policy.

5. The method of claim 4, wherein the rate is a maximum rate for the traffic exchanged.

6. The method of claim 3, wherein the access policies comprise at least one security policy to block remote access request from a set of network addresses to a virtual desktop application associated with the security policy.

7. The method of claim 3, wherein the access policies comprise at least one web access firewall (WAF) policy to apply to a set of network addresses that try to access a virtual desktop application associated with the WAF policy.

8. The method of claim 3, wherein the access policies comprise a particular access policy applicable to a particular virtual desktop application.

9. The method of claim 3, wherein the access policies comprise a particular access policy applicable to a particular group of two or more virtual desktop applications.

10. The method of claim 3, wherein the access policies comprise a particular access policy applicable to a particular virtual desktop that comprises a set of one or more applications.

11. A non-transitory machine readable medium storing a load-balancing program that performs load balancing for traffic exchanged between a remote client and a virtual desktop application, the program for execution by at least one processing unit, the program comprising sets of instructions for:
performing a load balancing operation to select a gateway to receive a request, from a remote client, to access the virtual desktop application;
receiving from a gateway data specifying (i) a resource that will provide the virtual desktop application and (ii) a first port to use to establish a connection with the resource to receive the virtual desktop application;
forwarding to the remote client the received data after replacing in the received data the first port with a second port;
creating a set of one or more connection tracking records that associates the first and second ports;
using the connection tracking record set subsequently to forward to the gateway data messages received from the remote client that have header that specify the second port as destination ports of the data messages.

12. The non-transitory machine readable medium of claim 11, wherein the program further comprises a set of instructions for replacing the second port with the first port in the data messages forwarded to the gateway from the remote client.

13. The non-transitory machine readable medium of claim 11, wherein the program further comprises sets of instructions for:
storing in the connection tracking record set identity of the virtual desktop application;
applying access policies on traffic exchanged between the remote client and the gateway based on the identity of the virtual desktop application that is retrieved from the connection tracking record set.

14. The non-transitory machine readable medium of claim 13, wherein the access policies comprise at least one rate limiting policy that specifies a rate associated with traffic exchanged between a remote client and a virtual desktop application associated with the rate limiting policy.

15. The non-transitory machine readable medium of claim 14, wherein the rate is a maximum rate for the traffic exchanged.

16. The non-transitory machine readable medium of claim 13, wherein the access policies comprise at least one security policy to block remote access request from a set of network addresses to a virtual desktop application associated with the security policy.

17. The non-transitory machine readable medium of claim 13, wherein the access policies comprise at least one web access firewall (WAF) policy to apply to a set of network addresses that try to access a virtual desktop application associated with the WAF policy.

18. The non-transitory machine readable medium of claim 13, wherein the access policies comprise a particular access policy applicable to a particular virtual desktop application.

19. The non-transitory machine readable medium of claim 13, wherein the access policies comprise a particular access policy applicable to a particular group of two or more virtual desktop applications.

20. The non-transitory machine readable medium of claim 13, wherein the access policies comprise a particular access policy applicable to a particular virtual desktop that comprises a set of one or more applications.

21. A method of enforcing a set of access policies on traffic exchanged between a remote client and a virtual desktop application, the method comprising:
forwarding to a gateway a request, from a remote client, to access the virtual desktop application;
receiving from a gateway data specifying (i) a resource that will provide the virtual desktop application and (ii) a first port to use to establish a connection with the resource to receive the virtual desktop application;
forwarding to the remote client the received data after replacing in the received data the first port with a second port;
creating a set of one or more connection tracking records that associates the first and second ports and an identifier associated with the virtual desktop application;
using the connection tracking record set subsequently to identify the virtual desktop application for traffic exchanged between the remote client and the resource, and to perform access policy enforcement on the traffic based on the identified virtual desktop application.
